(19) United States
(12) Patent Application Publication
(10) Pub. No.: US 2023/0315615 A1
(43) Pub. Date: Oct. 5, 2023

(54) GENERATING USER INTERFACE (UI) AUTOMATION TEST CASES FOR WORKFLOW AUTOMATION PLATFORM PLUGINS

(71) Applicant: Dell Products L.P., Round Rock, TX (US)

(72) Inventors: Yian ZONG, Shanghai City (CN); Hui LUO, Shanghai City (CN); Yunnan XU, Shanghai City (CN)

(73) Assignee: Dell Products L.P., Round Rock, TX (US)

(21) Appl. No.: 17/724,031

(22) Filed: Apr. 19, 2022

(30) Foreign Application Priority Data
Apr. 2, 2022 (CN) 202210350000.9

(51) Int. Cl. G06F 11/36

(52) U.S. Cl. CPC G06F 11/3684; G06F 11/3664

(57) ABSTRACT

A test script generation method identifies workflows associated with a workflow automation platform plugin accessed by a user. Test script generation operations are performed, including retrieving workflow-specific metadata, e.g., locator, type, and label data, and storing the retrieved data in a JSON file. The metadata may include metadata pertaining to UI elements referenced in the workflow. Disclosed methods may then generate test framework files based on the retrieved metadata and type/action rules that associate UI element types with known or predictable actions appropriate for the element type. The test framework files may include a page object file that maps UI elements to their locators, a configuration file that maps UI elements to testing data, and a test script file defining test script steps and test cases. A test framework may then be invoked to access the test framework files and execute test scripts in accordance with the test framework files.

### TECHNICAL FIELD

The present disclosure relates to information technology and, more particularly, information technology tasks and the automation thereof.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In data centers and other large scale deployments of information handling systems, automation of complex IT tasks including, as an illustrative example, a procedure for migrating a distributed database, is highly desirable. Workflow automation platforms are designed to simplify task automation. Such platforms may support the use of plugin modules to extend platform functionality. A potentially large number of third party plugin modules may be developed for a given automation platform.

Widely distributed workflow automation platforms may be updated frequently, e.g., monthly. Each such update may include modifications of the automation platform, including modifications of the platform's client modules that provide platform access to users. Each such modification may have a negative impact on plugin functionality. Manual testing of each of a potentially large number of plugin modules after each potentially frequent modification of an automation platform is impracticable. On the other hand, automating such a task is also challenging. Plugin modules, and their associated automation workflows, generally involve one or more user interfaces (UIs) and generating UI test scripts is a non-trivial process due, at least in part, to the highly specific nature of UIs.

### SUMMARY

In accordance with subject matter disclosed herein, a metadata driven method of generating test scripts for a plugin module, referred to herein simply as a plugin, associated with a workflow automation platform, referred to herein simply as an automation platform, identifies one or more workflows associated with a plugin that has been accessed or invoked by a user. For each identified workflow, test script generation operations are performed. In at least one embodiment, the test script generation operations for a particular workflow include retrieving workflow-specific metadata and storing the retrieved data in a file with a suitable data exchange format. The metadata may include metadata pertaining to UI elements referenced in the workflow. By way of example, the metadata of interest may include locator, type, and/or label data for each UI element. Disclosed methods may then generate test framework files based, at least in part, on a combination of the retrieved metadata and a set of defined rules, referred to herein as type/action rules that associate UI element types with known or predictable actions appropriate for the element type, e.g., a button element may be associated with a click action.

Retrieving the workflow metadata may include crawling a workflow automation client to identify UI elements referenced in a plugin that has been invoked or otherwise accessed by a user. Metadata for each of the identified elements may then be retrieved and stored to a file with a format that facilitates and supports data exchanges, e.g., a JavaScript Object Notation (JSON) file.

The metadata itself may include locator data identifying a UI element, type data indicative of a type of the UI element, and label data indicating a form input field. The test framework files may include a page object file that maps UI elements to their locators, a configuration file that maps UI elements to testing data, and a test script file defining test script steps and test cases. A test framework may then be invoked to access the test framework files and execute test scripts in accordance with the test framework files.

Accordingly, disclosed subject matter teaches a metadata driven test script generator. An exemplary implementation may feature command line-based Python scripts that leverage a Selenium Library to fetch metadata associated with UI elements included or referenced in workflows associated with a plugin of interest. A test framework, e.g., Robot Framework, may be invoked to generate test scripts based on the retrieved metadata and the type/action rules. By extending the metadata and the type/action rules, disclosed subject matter may be appropriate for general web applications and not limited to workflow automation plugins.

Because disclosed features generate test scripts directly from the web resource's metadata, manual testing is not required to construct records. If the web resource changes, the test scripts can be modified directly or the test generation process can be re-executed. In addition, because the type of each UI element is known, the action associated with each element is predictable. For example, a button is associated with a click while a dropdown list is associated with selection of a listed item. By relying on the type/action rules to determine or predict UI element actions, no tracing of user interactions is required.

Disclosed methods may leverage a test framework, such as Robot Framework, with a well-defined and well-known syntax, to generate test scripts. Although embodiments illustrated and described in more detail below describe use cases for workflow automation platform plugins, the metadata and type/action rules may be expanded to support other use cases.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a workflow automation platform in accordance with disclosed subject matter;

FIG. 2 illustrates a flow diagram of a method for automating test case generation for a workflow automation platform plugin;

FIG. 3 presents a graphical depiction of the method of FIG. 2; and

FIG. 4 illustrates an information handling system suitable for use in conjunction with disclosed subject matter.

### DETAILED DESCRIPTION

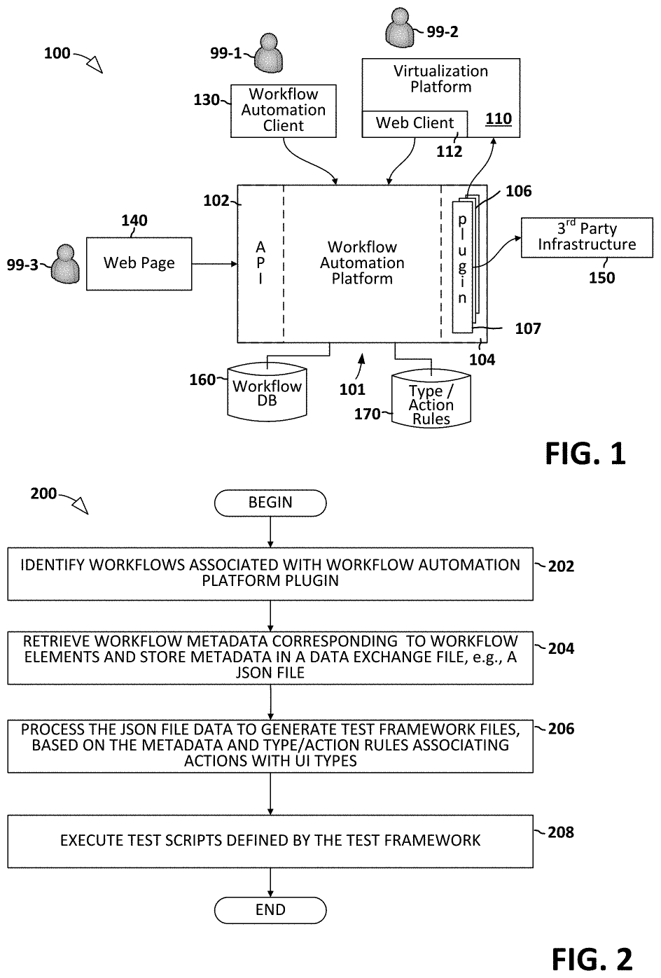

Exemplary embodiments and their advantages are best understood by reference to FIGS. 1-4, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Turning now to the drawings, FIG. 1 illustrates an information handling system 100 suitable for implementing disclosed features for workflow automation and, more specifically, automated generation of test scripts for workflow automation platform plugin modules. The information handling system 100 illustrated in FIG. 1 includes a virtualization platform 110 communicatively coupled to a workflow automation platform 101 suitable for facilitating the automation of IT tasks.

For the sake of clarity and brevity, whenever information handling system 100 is described herein with references to a specific implementation or embodiment, the references may be limited to implementations or embodiments based on virtualization and automated workflow platforms from VMware. Those of ordinary skill in the field will, however, appreciate that references to VMware implementations, do not limit disclosed teachings to the referenced implementations.

In at least one embodiment, workflow automation platform 101 may be or may include features of or features analogous to features found in a vRealize Orchestrator (vRO) workflow automation platform from VMware while the illustrated virtualization platform 110 may be, or may include features of or features analogous to features found in a vSphere virtualization platform from VMware.

FIG. 1 depicts users 99 accessing workflow automation platform 101 in various ways. A first user 99-1 accesses automation platform 101 directly from a workflow automation client 130, referred to herein simply as automation client 130, a second user 99-2 accesses automation platform 101 from a web client 112 embedded in the virtualization platform 110, and a third user 99-3 is depicted in FIG. 1 accessing automation platform 101 from a browser/web page 140 through an automation platform application programming interface (API) 102.

The illustrated information handling system further includes a workflow database 160 and a type/action rules database 170, both coupled to automation platform 101. As suggested by its name, workflow database 160 includes one or more sets of workflows, each of which may be associated with an automation platform plugin as described below. The type/action rules database 170 may include one or more tuples or other suitable data structures, each of which associates a user interface (UI) element type with one or more corresponding user actions. To illustrate by way of example, because it is expected that a user will input a text string or other appropriate value into a ‘text box’ element, type/action rules database 170 may include a data structure establishing an association between a ‘text box’ UI type and an ‘input value’ action. Similarly, type/action rules database 170 may associate a ‘checkbox’ UI type with a ‘check’ or ‘uncheck’ user action, and a ‘dropdown list’ UI type may be associated with a ‘select option from list’ action.

The automation platform 101 depicted in FIG. 1 includes a plugin library 104 containing one or more workflow automation plugins, of which two are specifically identified in FIG. 1. A first workflow automation plugin, referred to herein as native plugin 106, extends workflow automation functionality to infrastructure that is embedded within or native to virtualization platform 110. A second workflow automation plugin, referred to herein as external plugin 107, executes in conjunction with third party infrastructure 150. Although FIG. 1 depicts plugin library 104 with a single native plugin 106 and a single external plugin 107, it will be appreciated that plugin library 104 may include more than one native plugins 106 and/or more than one external plugins 107.

In embodiments of information handling system 100 that employ vRO as the workflow automation platform 101 and vSphere as the virtualization platform 110, plugin library 104 may contain any of various preconfigured native plugins 106 including, as non-limiting examples, a configuration manager plugin, an update manager plugin, a cloud director, a service manager plugin, and the like.

Plugin library 104 may also contain any of a wide variety of external plugins 107 associated with a broad and diverse range of third party infrastructure 150. In one exemplary embodiment, third party infrastructure 150 may consist of or include third party storage resources. In such an embodiment, each external plugin 107 in plugin library 104 may deliver a library of workflows that enables automation of storage provisioning and data protection operations. Commercially distributed examples of external plugins for storage resources include various vRO plugins for Dell EMC storage such as a vRO PowerMax plugin, a vRO PowerScale plugin, and a vRO PowerStore plugin.

Turning now to FIG. 2, a flow diagram illustrates a method 200 for automatically generating UI automation test scripts for an automation platform plug-in such as an external vRO plugin. The illustrated method 200 may be triggered when a user 99 (FIG. 1) selects or invokes one of the external plugins 107 in plugin library 104. The illustrated method 200 identifies (operation 202) one or more workflows, stored in workflow database 160 (FIG. 1) or elsewhere, associated with external plugin 107 (FIG. 1).

In operation 204 of the illustrated method 200, workflow metadata is retrieved and stored in a JSON file or another type of file with a format suitable for data exchange operations. Workflow metadata may be retrieved by crawling a workflow automation client, e.g., vRO client 130 (FIG. 1) to identify the UI elements referenced in the applicable workflow. In at least one embodiment, workflow metadata may include locator data, element type data, and label data. Locator data may include data indicative of a locator associated with the particular element. Any of various types of locators may be supported. In embodiments that incorporate an automation framework library such as a Selenium library, supported locators may include cascaded style sheets (CSS) ID locators, xpath locators, etc. Element type data may include data indicative of a type of UI element including, as examples, text field, dropdown list, checkbox, text area, multi-select, array, multi-value-picker, data grid, etc.

In operation 206, the JSON file data is accessed and processed to generate one or more test framework files suitable for use in conjunction with a Robot Framework or another suitable test framework. Generating the test framework files may include generating a page object file mapping UI elements and locators, a configuration file mapping UI elements and testing data, and a test file defining test script steps and test cases.

In operation 208, a test automation framework is invoked to execute test scripts based on the test framework files.

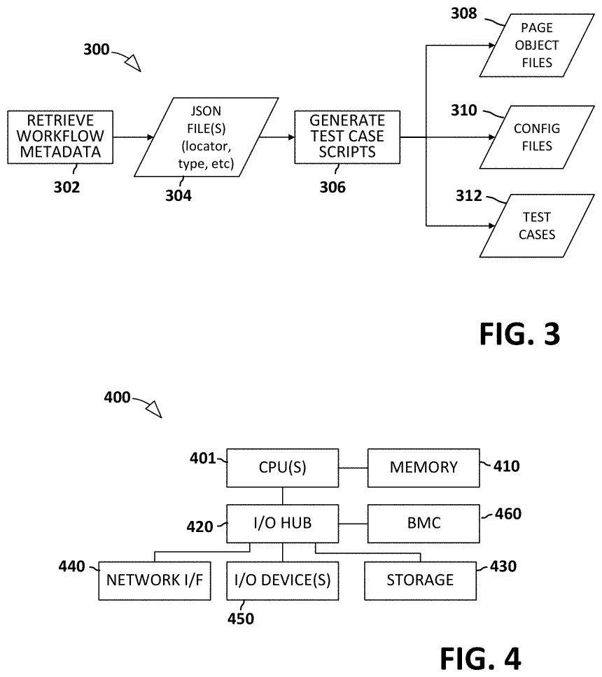

FIG. 3 illustrates a process 300 that includes the retrieval of workflow metadata in block 302, to produce JSON files 304 including locator, type, and label data corresponding to the UI elements within the plugin's associated workflows. The JSON files 304 may then be retrieved or otherwise accessed and processed in block 306 to create and store one or more test framework files. The test framework files illustrated in FIG. 3 include a page object file 308, a configuration file 310 and a test script file 312 defining test script steps and test cases.

Referring now to FIG. 4, any one or more of the elements illustrated in FIG. 1 through FIG. 3 may be implemented as or within an information handling system exemplified by the information handling system 400 illustrated in FIG. 4. The illustrated information handling system includes one or more general purpose processors or central processing units (CPUs) 401 communicatively coupled to a memory resource 410 and to an input/output hub 420 to which various I/O resources and/or components are communicatively coupled. The I/O resources explicitly depicted in FIG. 4 include a network interface 440, commonly referred to as a NIC (network interface card), storage resources 430, and additional I/O devices, components, or resources 450 including as non-limiting examples, keyboards, mice, displays, printers, speakers, microphones, etc. The illustrated information handling system 400 includes a baseboard management controller (BMC) 460 providing, among other features and services, an out-of-band management resource which may be coupled to a management server (not depicted). In at least some embodiments, BMC 460 may manage information handling system 400 even when information handling system 400 is powered off or powered to a standby state. BMC 460 may include a processor, memory, an out-of-band network interface separate from and physically isolated from an in-band network interface of information handling system 400, and/or other embedded information handling resources. In certain embodiments, BMC 460 may include or may be an integral part of a remote access controller (e.g., a Dell Remote Access Controller or Integrated Dell Remote Access Controller) or a chassis management controller.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method, comprising:
identifying one or more workflows associated with a plugin for a workflow automation platform; and
for each of the one or more workflows, performing test script generation operations, wherein the test script generation operations include:
retrieving metadata corresponding to user interface (UI) elements included in the one or more workflows; and
generating, in accordance with the retrieved metadata and type/action rules indicating user actions associated with UI element types, one or more test scripts for the plugin.

2. The method of claim 1, wherein retrieving the workflow metadata includes:
crawling a workflow automation client to identify one or more UI elements;
retrieving data for each of the one or more UI elements; and
storing the data in a data exchange file.

3. The method of claim 2, wherein the one or more UI elements include:
locator data indicative of a locator for each UI element;
type data indicative of an element type for each UI element; and
label data indicative of a form input field.

4. The method of claim 2, wherein generating the test scripts includes:
generating test framework files based on the workflow metadata and the type/action rules, wherein the test framework files include:
a page object file mapping UI elements to locator data;
a configuration file mapping UI elements and test data; and
a test automation file including the test scripts defining steps and test cases.

5. The method of claim 4, wherein generating the test framework files includes generating test framework files for a Robot Framework.

6. The method of claim 1, wherein the workflow automation platform comprises a vRealize Orchestrator (vRO) platform.

7. The method of claim 6, wherein the plugin comprises an external plugin extending the workflow automation platform to third party infrastructure.

8. The method of claim 7, wherein the third party infrastructure comprises third party storage resources.

9. An information handling system, comprising
a central processing unit (CPU); and
a non-transitory memory including process executable instructions that, when executed by the CPU, cause the system to perform method steps, wherein the method steps include:
identifying one or more workflows associated with a plugin for a workflow automation platform; and
for each of the one or more workflows, performing test script generation operations, wherein the test script generation operations include:
retrieving metadata corresponding to user interface (UI) elements included in the one or more workflows; and
generating, in accordance with the retrieved metadata and type/action rules indicating user actions associated with UI element types, one or more test scripts for the plugin.

10. The information handling system of claim 9, wherein retrieving the workflow metadata includes:
crawling a workflow automation client to identify one or more UI elements;
retrieving data for each of the one or more UI elements; and
storing the data in a data exchange file.

11. The information handling system of claim 10, wherein the one or more UI elements include:
locator data indicative of a locator for each UI element;
type data indicative of an element type for each UI element; and
label data indicative of a form input field.

12. The information handling system of claim 10, wherein generating the test scripts includes:
generating test framework files based on the workflow metadata and the type/action rules, wherein the test framework files include:
a page object file mapping UI elements to locator data;
a configuration file mapping UI elements and test data; and
a test automation file includes the test scripts defining steps and test cases.

13. The information handling system of claim 12, wherein generating the test framework files includes generating test framework files for a Robot Framework.

14. The information handling system of claim 9, wherein the workflow automation platform comprises a vRealize Orchestrator (vRO) platform.

15. The information handling system of claim 14, wherein the plugin comprises an external plugin extending the workflow automation platform to third party infrastructure.

16. The information handling system of claim 15, wherein the third party infrastructure comprises third party storage resources.
